(19) United States
(12) Patent Application Publication
(10) Pub. No.: US 2009/0007038 A1
(43) Pub. Date: Jan. 1, 2009

(54) HYBRID COUNTEREXAMPLE GUIDED ABSTRACTION REFINEMENT

(75) Inventors: Chao Wang, Plainsboro, NJ (US); Aarti Gupta, Princeton, NJ (US); Hyondeuk Kim, Boulder, CO (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/950,730

(22) Filed: Dec. 5, 2007

Related U.S. Application Data
(60) Provisional application No. 60/910,231, filed on Apr. 5, 2007.

(51) Int. Cl. G06F 17/50

(52) U.S. Cl. 716/5; 716/18

(57) ABSTRACT

Systems and methods are disclosed for performing counterexample guided abstraction refinement by transforming a design into a functionally equivalent Control and Data Flow Graph (CDFG); performing a hybrid abstraction of the design; generating a hybrid abstract model; and checking the hybrid abstract model.

The present application claims priority to Provisional Application Ser. No. 60/910,231 filed Apr. 5, 2007, the content of which is incorporated by reference.

### BACKGROUND

The present invention relates to abstraction refinement of hardware or software.

Classic CEGAR (Counterexample guided Abstraction Refinement) is typically used to check whether a “property” is satisfied by a “model” (of a hardware design or a software program)—that's called model checking. When the original model is too large, model checking cannot be used directly. In that case, one can build a simplified model by omitting some details of the original model, and hope that the simplified model is enough to prove the property. The abstract model is built in such a way that it contains all behaviors of the original model, and maybe more—if that helps reducing the size.

FIG. 1 shows the classic CEGAR process. First, an initial abstraction of the design (hardware or software) is done (10). Next, the abstraction is generated (12). The abstraction goes through model checking process (14) and tested for counter-examples (16). If a counter example is not found, the abstraction is proven (18). If the counter-example is found, the process checks for feasibility of the abstracted counter-example (20) and checks for concrete counterexamples (22). If a concrete counter-example is found, the abstraction is refuted (24) and if not, the abstraction is refined using the counter-example as a guide (28).

Model checking is applied to the abstract model. If the property holds in the abstract model, it implies that the property holds in the original model. If the property does not hold, model checking produces a counterexample (CEX)—an execution trace showing how the property is violated. If that abstract counterexample corresponds to real trace in the original model (called feasible, or concretizable), then a real bug is found. Otherwise, the abstract model needs to be refined such that some of the “previously omitted details” will be added back, to make the simplified model more accurate.

Variable hiding and predicate abstraction are two frequently used abstraction techniques in CEGAR. Both methods create over-approximated models, and therefore are conservative with respect to universal properties such as LTL. Since the abstract model may have more behaviors than the concrete model, if a property holds in the abstract model, it also holds in the concrete model; however, if a property fails in the abstract model, it may still be correct in the concrete model. The abstraction refinement loop consists of three phases: abstraction, model checking, and refinement. Typically, one starts with a coarse initial abstraction and applies model checking. If the property fails in the abstract model and the model checker returns an abstract counterexample, a concretization procedure is used to check whether a concrete counterexample exists. If a concrete counterexample does not exist, the abstract counterexample is spurious. Spurious counterexamples are used during refinement to identify the needed information currently missing in the abstraction.

The variable hiding abstraction, or localization reduction, partitions the set of state variables of the model into a visible subset and an invisible subset. In the abstract model, the transition functions of visible variables are preserved as is, and the invisible variables are abstracted as pseudo-primary inputs. Since the invisible variables are left unconstrained, the abstract model has all possible execution traces of the original model, and possibly more. The cone-of-Influence (COI) reduction can be regarded as a special case of variable hiding abstraction, wherein variables in the transitive fan-in of the property variables are marked as visible. Program slicing in software analysis is similar to COI reduction, and can be viewed as another special case. Compared to COI reduction, which produces an exact model for deciding the given property, variable hiding in general is more aggressive and may lead to spurious counterexamples.

In variable hiding, the abstraction computation is efficient. Given a set of visible variables, the abstract model can be built directly from a textual description of the original system, without the need for computing the concrete transition relation in the first place. This is advantageous because in practice the concrete transition relation may be too complex to compute. However, in variable hiding only existing state variables and transition functions can be used to construct the abstract model, which in general limits the chance of finding a concise abstraction. Despite this restriction, variable hiding has been relatively successful in abstracting large hardware designs, especially when combined with the use of SAT solvers. This is because the models tend to be well-partitioned and as a result, system properties often can be localized to a few submodules.

Predicate abstraction is more flexible than variable hiding since it allows a choice of predicates for abstraction, and has been used to verify both software and hardware. In predicate abstraction, a finite set of predicates is defined over the set X of concrete state variables and each predicate corresponds to a fresh Boolean variable pᵢεP. With these predicates, the model is mapped from the concrete state space (induced by X) into an abstract state space (induced by P). The main disadvantage of predication abstraction is the expensive abstraction computation. Unlike in variable hiding, this computation is not compositional; the worst-case complexity is exponential in the number of predicates. When the number of predicates is large, the abstraction computation time often goes up significantly. Cartesian abstraction has been proposed to alleviate this problem; however, it leads to a further loss of accuracy in the abstraction.

Traditional hardware models are well structured, in that existing state variables and transition functions are often sufficient for constructing a concise abstraction for most user-defined properties. In this case, exploiting the extra flexibility provided by predicate abstraction may not be very crucial. However, with the increasing use of higher level modeling and description languages in today's hardware design practice, the functional and structural partitionings may no longer directly correspond with each other, and as a result, the correctness of a property may not be easily localized to a few variables or submodules. In such cases, predicate abstraction is generally more effective. Furthermore, for system-level designs the boundary between hardware and software is getting blurred, and there is a need for abstraction method that work well on both.

### SUMMARY

In one aspect, a process for verifying the correctness of a design includes transforming the design into a Control and Data Flow Graph (CDFG); generating a hybrid abstract model; and checking the correctness of the hybrid abstract model.

In another aspect, a system to check a design includes a converter to transform the design into a Control and Data Flow Graph (CDFG); a module to perform a hybrid abstraction of the design and to generate a hybrid abstract model; and verifier to check the hybrid abstract model.

In yet another aspect, a hybrid abstraction method combines variable hiding with predicate abstraction in the same counterexample guided abstraction refinement loop. Refinements based on weakest preconditions to add new predicates can be used, and under certain conditions trade in the predicates for visible variables in the abstract model. Heuristics for improving the overall performance can be based on static analysis to identify useful candidates for visible variables, and lazy constraints can be used to find more effective refinement.

Advantages of certain embodiments of the system may include one or more of the following. The hybrid abstraction with the CEGAR framework can be used in verifying word-level Verilog designs. Experimental results show that the new method matches the better of the two existing abstraction methods, and outperforms them both in many cases. This may be due to the hybrid abstract model being more concise than either extreme when allowed to have both visible variables as well as predicates. Although hardware verification is discussed, the main ideas (and hybrid CEGAR) are directly applicable to verifying software programs also. The flexibility in the hybrid approach provides a uniform way to handle models derived from both hardware and software, and results in effective and concise abstractions automatically.

### BRIEF DESCRIPTION OF THE DRAWINGS

FIG. 1 shows an exemplary classic CEGAR process.

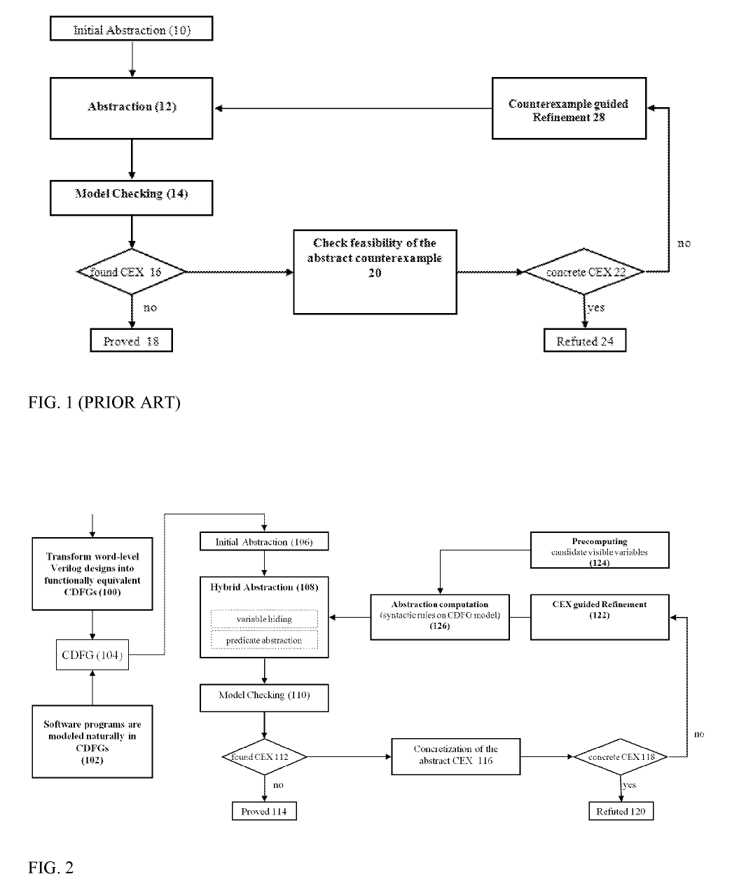

FIG. 2 shows a hybrid CEGAR process.

FIGS. 3-5 show exemplary abstractions of designs.

### DESCRIPTION

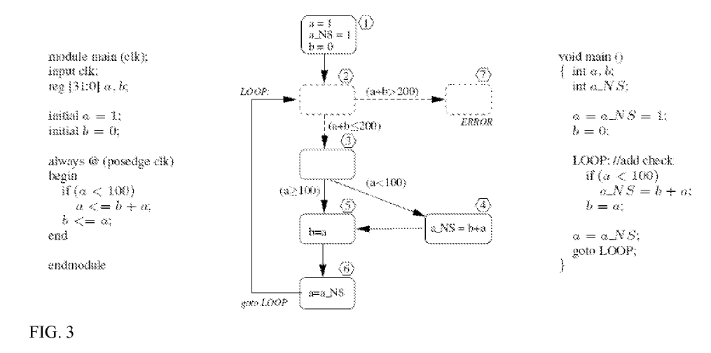

FIG. 2 shows a hybrid CEGAR process. The process of FIG. 2 automatically transforms word-level Verilog designs into functionally equivalent Control and Data Flow Graphs (CDFGs); the CDFGs serve as input to the CEGAR procedure. The method to apply the new hybrid CEGAR procedure to software programs (sequential model) or to word-level hardware (reactive model). First, the hardware design is transformed into a functionally equivalent control and data flow graph (CDFG) (100). Correspondingly, a software program can be directly modeled in a CDFG (102). Regardless of hardware or software design, the CDFG is received (104). Next, an initial abstraction of the design (hardware or software) is made (106). Next, a hybrid abstraction is generated (108) and includes variable hiding as well as predicate abstraction. Variable hiding and predicate abstraction are two popular abstraction methods to obtain simplified models for model checking. Variable hiding and predicate abstraction can be regarded as two extremes that have complementary strengths. The system's hybrid approach operates in the spectrum between the two extremes, to provide more robust and concise abstractions. Specifically, a hybrid abstraction is used that allows both visible state variables and predicates in the same abstract model. Algorithms are provided for optimizing the abstraction computation, and for deciding when to add more visible state variables and when to add more new predicates within a CEGAR framework. Heuristics also improves the overall performance, based on static analysis to identify useful candidates for visible variables, and use of lazy constraints to find more effective unsatisfiable cores for refinement.

The hybrid abstraction goes through model checking process (110) and tested for counter-examples (112). If a counter example is not found, the abstraction is proven (114). If the counter-example is found, the process checks for concrete counterexamples of the abstract counterexample (116). If a concrete counter-example is found, the abstraction is refuted (120) and if not, the abstraction is refined using the counter-example as a guide (122). An abstraction computation then applies syntactic rules on the CDFG model (126). The hybrid abstraction method allows both visible state variables and new predicates in the same abstract model. An efficient abstraction computation method is applied that uses a set of syntactic level rules to add correlation constraints (between visible variables and predicates, and among predicates) upfront. The method provides a heuristic refinement algorithm that uses word-level lazy constraints and unsatisfiability core (UNSAT core) computation to improve the quality of the refinement. The UNSAT core based refinement algorithm to add more “correlation constraints” lazily (on-demand) in order to remove spurious transitions. The abstraction computation also receives precomputed candidate visible variables (124). The process heuristically evaluates the cost of the hybrid abstract model and to decide, during refinement, when to trade new predicates for visible variables. A static analysis based method for pre-computing a list of candidate visible variables for hybrid abstraction, in order to avoid the overhead of discovering visible variables through multiple refinement steps. The abstraction computation is processed in the hybrid abstraction operation 108 and the process repeats.

The hybrid abstraction with the CEGAR framework can be used in verifying word-level Verilog designs. Experimental results show that the new method matches the better of the two existing abstraction methods, and outperforms them both in many cases. This may be due to the hybrid abstract model being more concise than either extreme when allowed to have both visible variables as well as predicates. Although hardware verification is discussed, the main ideas (and hybrid CEGAR) are directly applicable to verifying software programs also. The flexibility in the hybrid approach provides a uniform way to handle models derived from both hardware and software, and results in effective and concise abstractions automatically.

Turning now to the Abstraction Methods, let X={x₁, . . . , xₘ} be a finite set of variables representing the current state of the model, and X′={x₁′, . . . , xₘ′} be the set of variables representing the next state; then a valuation \tilde{X} or \tilde{X}′ of the state variables represents a state. A model is denoted by the tuple <T, I>, where T(X,X′) is the transition relation and I(X) is the initial state predicate. \tilde{X} is an initial state if I(\tilde{X}) holds; similarly, (\tilde{X},\tilde{X}′) is a state transition if T(\tilde{X},\tilde{X}′) is true. In symbolic model checking, the transition relation of a model and the state sets are represented symbolically by Boolean functions in terms of a set of state variables. For hardware models, all state variables are assumed to belong to finite domains. The concrete transition relation T(X,X′) is defined as follows,

$$T = {{⋀}^{m}}_{i = 1} {T}_{i} ( X , {X}^{′} ) ,$$

where Tᵢ is an elementary transition relation. Each xᵢεX has an elementary transition relation Tᵢ, defined as xᵢ′=δᵢ(X), where δᵢ(X) is the transition function of xᵢ.

Variable hiding marks a subset Xᵥ={x₁, . . . , xₙ}⊂ X of state variables as visible. The set of remaining variables (called invisible variables) is denoted by Xᵢₙᵥ=(X\Xᵥ). For xᵢεXᵢₙᵥ, let Tᵢ=true. The abstract model (via variable hiding) is defined as <T_{V},I_{V}> such that,

$${T}_{V} = {{⋀}^{n}}_{i = 1} {T}_{i} ( X , {X}^{′ } )$$

$${I}_{V} = ∃ {X}_{inv} \cdot I ( X )$$

T_{V}(X,Xᵥ′) may depend on some invisible current-state variables in Xᵢₙᵥ, which are treated as free inputs. In model checking, free inputs are existentially quantified during image computation. One can explicitly remove Xᵢₙᵥ variables by existential quantification,

\hat{T}ᵥ=∃Xᵢₙᵥ·T_{V}(X,Xᵥ′)

However, this may cause a further loss of accuracy since T_{V}⊂\hat{T}_{V}. In practice, using T_{V} as opposed to \hat{T}_{V} in model checking often gives better results.

In predicate abstraction, consider a set P={P₁, . . . , Pₖ} of predicates over variables in X. A new set P={p₁, . . . , pₖ} of Boolean state variables are added for the predicates such that pᵢ is true if Pᵢ(X) evaluates to true. The abstract model (via predicate abstraction) is defined as <T_{P},I_{P}> such that,

$${T}_{P} = ∃ X , {X}^{′} \cdot T ( X , {X}^{′} ) ⋀ {{⋀}^{k}}_{i = 1} {p}_{i} ↔ {P}_{i} ( X ) ⋀ {p}_{i}^{′} ↔ {P}_{i}^{′} ( X )$$

$${I}_{P} = ∃ X \cdot I ( X ) ⋀ {{⋀}^{k}}_{i = 1} {p}_{i} ↔ {P}_{i} ( X )$$

The mapping from T to T_{P}, or predicate image computation, is expensive. Most existing tools developed for hardware verification use either BDDs or a SAT solver to compute the predicate image. For instance, one can build a Boolean formula for T(X,X′)̂ [symbol] pᵢ [symbol] Pᵢ(X)̂pᵢ′ [symbol] Pᵢ(X′) as the input to a SAT solver; T_{P}(P,P′) is obtained by enumerating all the satisfying solutions of the formula in terms of variables in P and P′.

In the worst case, the number of satisfying assignments in T_{P} is exponential in the number of predicates. Abstraction computation may become intractable when the number of predicates is large. In such cases, one has to resort to a less precise abstract transition relation \hat{T}_{P} (such that T_{P}⊂\hat{T}_{P}). In Cartesian abstraction, for instance, the set P is partitioned into smaller subsets where predicate images are computed separately for each individual subset, and the resulting relations are conjoined together to obtain \hat{T}_{P}.

Next, the cost of Abstractions is discussed. The conciseness of abstraction in terms of the number of Boolean state variables in the abstract model is evaluated. In model checking, the state space is exponential in the number of state variables, making the number of state variables an effective indicator of the hardness of model checking.

Turning now to the cost of a Predicate, in variable hiding abstraction, a visible variable xᵢεXᵥ with domain dom(xᵢ) has a cost equal to log|dom(xᵢ)|, where |dom(xᵢ) | is the cardinality of the set. If binary encoding is used for xᵢ in the concrete model and log|dom(xᵢ)| is the number of bits for encoding xᵢ, the cost of an invisible variable is 0. In predicate abstraction, since all variables in P are in the Boolean domain, the cost of each pᵢεP or each corresponding predicate Pᵢ(X) is 1. To facilitate the comparison of predicate abstraction with variable hiding, the cost of pᵢ(which is 1) is distributed evenly to the concrete state variables in Pᵢ(X) as follows: If there are l supporting X variables appearing in the expression Pᵢ(X), the predicate adds a cost of (1/l) to each of these variables. When there are visible variables, the cost of a predicate is distributed evenly to its supporting invisible variables only. If all the variables appearing in Pᵢ(X) are already made visible, then the predicate is redundant since adding it will not improve the accuracy of the abstraction.

### EXAMPLE 1

The predicate P₁:(u+v>10) adds ½ each to the costs of u and v; the predicate P₂: (u−2v≦3w) adds ⅓ each to the costs of u, v, and w.

### EXAMPLE 2

When u is a visible variable, the predicate P₁:(u+v>10) adds 1 to the cost of v, the predicate P₂:(u−2v≦3w) adds ½ each to the costs of v and w, and P₃:(u≠0) is redundant.

The total cost distributed to a concrete state variable xᵢεX by predicates, denoted by cost_{P}(xᵢ), is the sum of the costs incurred by all the predicates in which xᵢ appears. Recall that in variable hiding, the cost of xᵢεX is log|dom(xᵢ)| when it is visible. Therefore, if cost_{P}(xᵢ)>log|dom(xᵢ)|, then predicate abstraction is considered to be less concise, since making xᵢ visible requires less Boolean state variables than representing the predicates. On the other hand, if cost_{P}(xᵢ)<log|dom(xᵢ)|, then predicate abstraction is considered to be more concise.

Turning now to the cost of a Visible Variable, variable hiding can be viewed as a special case of predicate abstraction, wherein all possible valuations of a visible variable are provided as predicates.

In predicate abstraction, T_{P}(P,P′) is defined in the abstract state space; however, it can be mapped back to the original state space as follows, T_{P}(Y,Y′)=

$$∃ ( P , {P}^{′} ) \cdot {T}_{P} ( P , {P}^{′} ) ⋀ {{⋀}^{k}}_{k = 1} {p}_{i} ↔ {P}_{i} ( Y ) ⋀ {p}_{i}^{′} ↔ {P}_{i} ( {Y}^{′} )$$

Here Y and Y′ are used to represent the same sets of state variables as X and X′. According to the mapping from T(X,X′) to T_{P}(P,P′), then T_{P}(Y,Y′)=

$$∃ ( X , {X}^{′} ) \cdot T ( X , {X}^{′} ) ⋀ {{⋀}^{k}}_{i = 1} {P}_{i} ( Y ) ↔ {P}_{i} ( X ) ⋀ {P}_{i} ( {Y}^{′} ) ↔ {P}_{i} ( {X}^{′} )$$

This equation is interpreted as follows: In order to allow all the visible variables in T(X,X′) to be preserved, while existentially quantifying invisible variables, one can define a set of new predicates for each xᵢεXᵥ as follows: let dom(xᵢ)={d₁, . . . , dₗ}, the set of predicates is {(xᵢ=d₁),(xᵢ=d₂), . . . ,(xᵢ=dₗ)}.

However, preserving a visible variable xᵢ using these predicates may be inefficient since it requires |dom(xᵢ)| new Boolean state variables, one for each predicate (xᵢ=dⱼ). In contrast, making xᵢ visible only requires log|dom(xᵢ)| Boolean state variables. If all these predicates (representing valuations of xᵢεXᵥ) are needed in order to decide the property at hand, then variable hiding provides an exponentially more concise abstraction.

Next, a hybrid abstraction method is presented that allows visible variables and predicates to be in the same abstract model. Given a set Xᵥ={x₁, . . . , xₙ} of visible variables and a set {P₁, . . . , Pₖ} of predicates, together with a set P={p₁, . . . , pₖ} of fresh Boolean variables, T_{H}(X,P,X′,P′), the new hybrid abstract transition relation, is defined as follows,

$${T}_{H} = {T}_{V} ( X , {X}_{v}^{′} ) ⋀ {T}_{P} ( P , {P}^{′ } ) ⋀ {{⋀}^{k}}_{i = 1} {p}_{i} ↔ {P}_{i} ( X )$$

The model can be viewed as a parallel composition of two abstract models T_{V} and T_{P}, defined in terms of Xᵥ and P variables, and connected through the correlation constraint [symbol] pᵢ [symbol] Pᵢ(X). Without loss of generality, for every predicate Pᵢ(X), at least one of its supporting X variables is invisible. (If all supporting X variables in Pᵢ are visible, the redundant predicate Pᵢ is removed.)

Since adding the correlation (third conjunct in the above formula) can make model checking significantly more expensive (due to a large BDD for T_{H}), a less precise abstraction can be used

\hat{T}_{H}=T_{V}(X,Xᵥ′)̂\hat{T}_{P}(P,P′)

Note that in addition to removing the correlation constraint between X and P, T_{P} is replaced by \hat{T}_{P} (Cartesian abstraction)— this removes the potential correlation among P variables. The advantage of using \hat{T}_{P} is that it is cheaper to compute. The syntactic cone partitioning method can be used to enumerate the elementary transition relation of each predicate separately. That is, each next-state predicate Pᵢ(X′) is clustered with all the current-state predicates Pⱼ(X) such that the supporting X variables of Pⱼ(X) affect the next-state values of the supporting X′ variables of Pᵢ(X′). If the correlation among some P variables is missing because of this Cartesian abstraction, it will be added back if needed during refinement.

The loss of both kinds of correlation constraints can cause spurious transitions to appear in the abstract model. An abstract transition (s,s′), where s and s′ are valuations of variables in (P∪Xᵥ) and (P′∪Xᵥ′), respectively, is spurious if no concrete transition exists between (s,s′). There are two possible reasons for a spurious counterexample to appear: (1) there are spurious transitions because the abstraction computation in \hat{T}_{H} is not precise; and (2) there are spurious counterexample segments because the sets of predicates and visible state variables are not sufficient. Note that a counterexample segment may be spurious even if none of its transition is spurious. During refinement, spurious transitions are removed, by identifying some needed constraints over variables in Xᵥ, Xᵥ′, P, and P′ and conjoining them with \hat{T}_{H}.

Refinement for Spurious Transitions will be discussed next. For a spurious transition (s,s′), there is no concrete transition between s and s′ but \hat{T}_{H}(s,s′) is. Let the abstract state s={ p̅₁, . . . , p̅ₖ, x̅₁, . . . x̅ₙ} be a valuation of variables in P∪Xᵥ and s′ be a valuation of the variables in P′∪Xᵥ′, then (s,s′) is spurious if the formula R(X,P,X′,P′), defined below, is not satisfiable.

$$T ⋀ {{⋀}^{n}}_{i = 1} {x}_{i} = {\overline{x}}_{i} ⋀ {x}_{i}^{′} = {\overline{x}}_{i}^{′} ⋀ {{⋀}^{k}}_{i = 1} {P}_{i} ( X ) ↔ {\overline{p}}_{i} ⋀ {P}_{i} ( {X}^{′} ) ↔ {\overline{p}}_{i}^{′}$$

A Boolean formula R is built for each abstract transition in the given counterexample, and use a SAT solver to check its satisfiability. If the formula is not satisfiable, then the transition is spurious.

Removing the spurious transition requires the addition of a constraint r(X,P,X′,P′), i.e., conjoining \hat{T}_{H} with r. The additional constraint r is defined as follows,

$$r = ( {{⋀}^{n}}_{i = 1} {x}_{i} = {\overline{x}}_{i} ⋀ {x}_{i}^{′} = {\overline{x}}_{i}^{′} ⋀ {{⋀}^{k}}_{i = 1} {p}_{i} ↔ {\overline{p}}_{i} ⋀ {p}_{i}^{′} ↔ {\overline{p}}_{i}^{′} )$$

The constraint r can be strengthened by dropping the equality constraints on some irrelevant X and P variables. The irrelevant variables can be determined by analyzing the UNSAT core reported by the SAT solver. An UNSAT core of a Boolean formula is a subset of the formula that is sufficient for proving the unsatisfiability. If certain subformulas in R, such as xᵢ= x̅ᵢ and Pᵢ(X) [symbol] p̅ᵢ, do not appear in the UNSAT core, then the equality constraints can be dropped from r. The strengthened version of r is guaranteed to remove the spurious transition at hand.

If there is no spurious transition in a spurious counterexample, more predicates or visible variables are needed to refine the abstract model. Let X^{j}∪P^{j} be the copy of (X∪P) at the j-th time frame. If the counterexample s₀, . . . , s₁ is spurious, the following formula is unsatisfiable,

$${{⋀}^{l - 1}}_{j = 0} R ( {X}^{j} , {P}^{j} , {X}^{j + 1} , {P}^{j + 1} )$$

Note that each R is satisfiable by itself. The spurious counterexample can be removed by using a weakest precondition (WP) based refinement method. Since the weakest precondition computation relies on the underlying representation of the concrete model, the refinement is discussed in more detail after the discussion of the hybrid CEGAR procedure.

The hybrid CEGAR procedure is presented based on models represented as Control and Data Flow Graphs (CDFGs). Intuitively, the CDFG representation allows a separation between control and data state, such that control states are represented explicitly in terms of basic blocks (with guarded transitions between blocks) and data states are represented implicitly in terms of symbolic data variables (with assignments that update data state). This provides a natural representation for software programs, where control states correspond to control locations of the program and data states to values of program variables. For hardware models, Verilog is used as a representative HDL, and describe how to obtain CDFGs from word-level Verilog designs—this has certain features that impact the proposed abstraction and refinement techniques.

The CDFG is a concrete model, serving as input to the hybrid CEGAR procedure. The hybrid abstract model is computed directly from the CDFG model, with respect to a set Xᵥ of visible variables and a set P={P₁, . . . , Pₖ} of predicates.

In transforming Verilog Designs into CDFGs, the Verilog design is transformed through rewriting to a functionally equivalent reactive program. This reactive program is formally represented as a control and data flow graph (CDFG).

### DEFINITION 3

A control and data flow graph (CDFG) is a 5-tuple <B,E,V,Δ, θ> such that
B={b₁, . . . , b_{L}} is a finite set of basic blocks, where b₁ is the entry basic block.
E⊂B×B is a set of edges representing transitions between basic blocks.
V is a finite set of variables that consists of actual variables in the design and auxiliary variables added for modeling the synchronous semantics of hardware description.
Δ:B→2^{S}^{_{asgn}} is a labeling function that labels each basic block with a set of parallel assignments. S_{asgn} is the set of possible assignments.
θ:E→S_{cond} is a labeling function that labels each edge with a conditional expression. S_{cond} is the set of possible conditional expressions.

### EXAMPLE 4

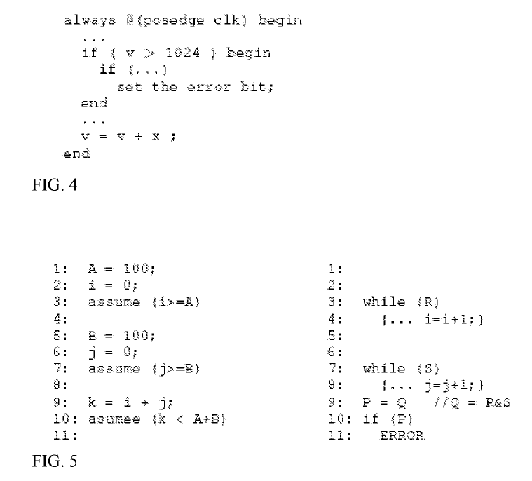

The Verilog example in FIG. 3 computes Fibonacci numbers. The equivalent CDFG is on the right. To maintain the synchronous semantics, the variable a_NS was added to hold the next-state value of the reg type variable a. The loop body corresponds to the execution of the always block exactly once (in a clock cycle). Since a<=b+a is a non-blocking assignment, i.e., a gets the current value of (b+a) at the next clock cycle (not immediately), when translating the assignment b<=a, a was not substituted by a_NS. Note that if it were a blocking assignment b=a+b and b=a in the Verilog description, they would be translated into a_NS=b+a and b=a_NS.

In FIG. 3, each rectangle in the CDFG is a basic block and the edges are labeled by conditional expressions. For example, the transition from block 3 to block 4 is guarded by (a<100). Edges not labeled by any condition are assumed to have a label. Block 1 is the entry block and block 7 is the error block. Reachability properties in the Verilog model are translated into assertion checks at the beginning of the loop. For example, (a+b≦200) is translated into if(a+b>200) ERROR. The verification problem consists of checking whether the ERROR block is reachable from the entry block. More complex properties (PSL or LTL) can be handled by first synthesizing them into monitors followed by the Verilog-to-CDFG translator.

The transformation from Verilog designs to CDFG representations is made easy by introducing the NS variables. The CDFG is a representation similar to a software program, except that it has a single infinite loop to emulate the reactiveness of a hardware model. A clock cycle in the Verilog model corresponds to the execution of the loop body of the CDFG exactly once. Procedural statements from all the always blocks are sequentialized inside the infinite loop. Due to the addition of extra _NS variables for the reg type variables, e.g., a_NS for a as in FIG. 3, sequentialization of multiple synchronously running always blocks may take an arbitrary order. In one implementation, an order is selected that can minimize the number of added _NS variables, since such optimizations reduce the size of the concrete model and therefore speed up model checking.

The CDFG model is chosen in order to directly apply weakest-precondition based predicate abstraction refinement algorithms that have been developed for software programs. In the traditional synchronous model, these WP-based refinement algorithms are not directly applicable. Note that a synchronous model for Verilog designs is equivalent to summarizing all the statements in the loop body of the CDFG model, and creating a single basic block with a self loop, and with a set of parallel running assignments, one for each register variable. Such a synchronous circuit model (as opposed to a reactive program) can be used, where significant modifications have to be made to the WP-based refinement algorithm. Even with these modifications, one has to simultaneously consider all possible branches inside each clock cycle, making the WP computation likely to blow up. In contrast, in the CDFG representation, the weakest precondition computation can be localized to a single execution path, therefore offering the possibility of creating abstraction at a finer granularity. Abstraction computation is also faster in the reactive model since SAT enumeration can be applied to assignments in each individual block of the CDFG, as opposed to all assignments of the single block of a synchronous model simultaneously.

Next, hybrid abstraction refinement for CDFGs will be discussed. A special state variable x_{pc}, the program counter (PC), is added to represent the control locations of the CDFG; the domain of x_{pc} is the set B of basic blocks. The set X of state variables of the model is assumed to be {x_{pc}}∪V. In the sequel, x_{pc} is always the first element of X and therefore x_{pc} and x₁ are interchangeable. The initial states of the model are modeled as I=(x₁=b₁), i.e., all possible valuations of V in the entry block b₁. If the error block is b_{Err}εB, the property to be verified is (x₁≠b_{Err}). The set of parallel assignments in each basic block bⱼεB, denoted Δ(bⱼ), is written as x₂, . . . , xₘ←e_{2,j}, . . . , e_{m,j}, where e_{m,j} is the expression assigned to xₘ in block bⱼ. The guard c_{j,k}=θ(bⱼ,bₖ) is the edge label from block bⱼ to block bₖ; if there is no such edge, c_{j,k}=false.

In trading Predicates for Visible Variables, with the hybrid abstraction, x₁ is always visible. Xᵥ={x₁} and P={ }, and new predicates can be added using WP-based refinement. At the same time, the system checks to see if it is advantageous to trade some existing predicates for visible variables as follows:
Add new visible variables: For all xᵢεXᵢₙᵥ, if the total cost distributed to xᵢ by predicates is larger than log|dom(xᵢ)|, xᵢ is made visible, i.e., the system adds xᵢ in Xᵥ.
Remove redundant predicates: For a predicate Pᵢ(X) whose supporting X variables are all visible, the system removes the predicate and remove the corresponding pᵢ from P.

Modify correlation constraints: For all existing correlation constraints r(Xᵥ,P,Xᵥ′,P′), if pᵢ and pᵢ′ are in the support of r, but Pᵢ(X) has been declared as redundant and removed, the system existentially quantifies pᵢ and pᵢ′ from r, i.e., the system uses ∃(pᵢ,pᵢ′)·r(Xᵥ,Xᵥ′,P,P′) instead.

The initial hybrid abstract transition relation is \hat{T}_{H}=T_{V}̂\hat{T}_{P}. Given a set Xᵥ, the system computes T_{V}= [symbol] Tᵢ as follows: For x₁εXᵥ, T₁, represents the control flow logic,

$${T}_{i} = {{⋁}^{L}}_{j = 1} {{⋁}_{k = 1}}^{L} ( {x}_{1} = {b}_{j} ) ⋀ ( {x}_{1}^{′} = {b}_{k} ) ⋀ {c}_{j , k}$$

Since invisible variables are treated as free inputs, if c_{i,k}(X) contains invisible variables, the guard is nondeterministically chosen to be true or false (corresponding to if(*)). For xᵢεXᵥ such that i≠1,

$${T}_{i} = {{⋁}^{L}}_{j = 1} ( {x}_{1} = {b}_{j} ) ⋀ ( {x}_{i}^{′} = {e}_{i , j} ) ,$$

wherein e_{i,j}(X) is the RHS expression assigned to xᵢ in block j. If there is no explicit assignment to xᵢ, then e_{i,j}=xᵢ.

Correlations between X and P variables, as well as correlations among P variables, are added lazily during refinement if spurious transitions occur. Next, the process for removing spurious counterexamples by adding new visible variables and predicates to Xᵥ and P, respectively, will be discussed.

In computing New Predicates in CDFGs, the system uses a weakest precondition based refinement algorithm for finding new predicates. Given a spurious counterexample with no spurious transition, first, the system identifies a subset of conditional expressions (guards) that are needed to prove the infeasibility of a concrete path. The system focuses on one path in the CDFG, blk₁, . . . , blkₙ, determined by the counterexample. In this path, a basic block may appear more than once. The sequence of statements π=st1, st2, . . . corresponding to this path consists of two kinds of statements: a basic block blkᵢ corresponds to a set of parallel assignments Δ(blkᵢ), and a transition (blkᵢ,blkᵢ₊₁) corresponds to a branching statement assume(c) where c=θ(blkᵢ,blkᵢ₊₁).

### EXAMPLE 5

A spurious counterexample segment in FIG. 3 corresponds to the sequence of basic blocks 1,2,3,5,6,2,7. The sequence of program statements is shown below:

| blocks | transitions | statements | inUNSAT |
|---|---|---|---|
| b₁ | | a = 1; | |
| | | a_NS = 1; | yes |
| | | b = 0; | yes |
| | b₁ → b₂ | | |
| b₂ | | | |
| | b₂ → b₃ | assume(a + b ≦ 200); | |
| b₃ | | | |
| | b₃ → b₅ | assume(a ≧ 100); | |
| b₅ | | b = a; | |
| | b₅ → b₆ | | |
| b₆ | | a = a_NS; | yes |
| | b₆ → b₂ | | |
| b₂ | | | |
| | b₂ → b₇ | assume(a + b > 200); | yes |

A SAT solver checks the feasibility of a counterexample segment, where an unsatisfiable formula indicates that the counterexample is spurious. For each c=θ(blkᵢ,blkᵢ₊₁), the system checks whether c appears in the UNSAT core. If it appears in the UNSAT core, then the guard c(X) is chosen and its weakest precondition WP(π,c) is computed with respect to the spurious prefix π. WP(π,φ) is the weakest condition whose truth before the execution of/entails φ after the execution. Let ƒ(V/W) denote the substitution of W with V in function ƒ(W). WP(π,φ) is defined as follows: (1) for an assignment s:(v=e), WP(s,φ)=φ(e/v); (2) for a conditional statement s:assume(c), WP(s,φ)=φ̂c; (3) for a sequence of statements st1;st2, WP(st1;st2,φ)=WP(st1,WP(st2,φ)). Refinement corresponds to adding the new predicates appearing in WP(π,c) to the abstract model.

In this example, suppose that the guard (a+b>200) appears in the UNSAT core and π is the sequence of statements in blocks 1,2,3,5,6 and 2. Then WP(π,a+b>200) provides the following new predicates: P₁:(a+b>200), P₂:(a_NS+b>200), P₃:(a_NS+a>200). Adding these predicates will remove the spurious counterexample, because in block 1, P₃=false; in blocks 5 and 6, P₂=P₃;P₁=P₂; this makes the transition from block 2 to block 7, guarded by (P₁), evaluate to false.

In the method, new predicates are directly added by the refinement algorithm, while visible variables are derived indirectly from the existing set of predicates by trading in predicates. An alternative is to selectively make some of the variables in the UNSAT core visible directly.

The system can eagerly add Syntactic Constraints. In \hat{T}_{H}, the constraints [symbol] pᵢ [symbol] Pᵢ(X) are left out completely, to make the abstraction computation cheaper. Although some of the needed correlation constraints can be lazily added during refinement of spurious transitions, this process can sometimes be inefficient due to the model checking expenses and number of refinement iterations. Therefore, certain cheaper constraints are added to \hat{T}_{H} upfront.

The following syntactic rules are used to decide which constraints to add. If \hat{T}_{H}=T_{V}̂\hat{T}_{P}= [symbol] Tᵢ̂ [symbol] Tₚ_{ᵢ}.

(Rule 1) for x₁εXᵥ (the PC variable),

$${T}_{1} = {{⋀}^{L}}_{j = 1} {{⋀}_{k = 1}}^{L} ( {x}_{1} = {b}_{j} ) ⋀ ( {x}_{1}^{′} = {b}_{k} ) ⋀ {c}_{j , k}$$

The conditional expressions c_{j,k}(X) is processed as follows:
if c_{j,k} is a constant (true or false), or all the supporting X variables of c_{j,k}(X) are visible, then do not change it;
else if c_{j,k}(X) is syntactically equivalent to (the negation of) a predicate Pₗ(X), then replace it by (the negation of) pₗ;
otherwise, replace it with (*), by adding a fresh primary input indicating a nondeterministic choice.

Note that in the third case, over-approximation of ∃Xᵢₙᵥ·C_{j,k}(X)̂ [symbol] pᵢ [symbol] Pᵢ(X) is used; however, there is no approximation in the first two cases.

(Rule 2) for xᵢεXᵥ such that i≠1 (non-PC variables),

$${T}_{i} = {{⋁}^{L}}_{j = 1} ( {x}_{1} = {b}_{j} ) ⋀ ( {x}_{i}^{′} = {e}_{i , j} )$$

e_{i,j}(X), the expression assigned to xᵢ in block j is not approximated. The system uses e_{i,j} as is, even if there are invisible variables in its support—these invisible variables become pseudo-primary inputs.

(Rule 3) for pᵢεP (predicate variables), Tₚ_{ᵢ} is the elementary transition relation of pᵢ. The computation of Tₚ_{ᵢ} is localized to the computation of Tₚ_{ᵢ}_{,j} in each basic block j (similar to xᵢ′=e_{i,j} for computing Tᵢ)

$${T}_{{p}_{i}} = {{⋁}^{L}}_{j = 1} ( {x}_{1} = {b}_{j} ) ⋀ {T}_{{p}_{i}} , j$$

where Tₚ_{ᵢ}_{,j}=∃Xᵢₙᵥ·WPⱼ(Pᵢ)̂ [symbol] pₗ [symbol] Pₗ(X).WPⱼ(Pᵢ) is used to denote the weakest precondition of Pᵢ(X) with respect to the assignments in block bⱼ. Since the existential quantification (∃Xᵢₙᵥ.) is expensive, the system computes Tₚ_{ᵢ}_{,j} as follows:
if WPⱼ(Pᵢ) is a constant (true or false), or in the expression of WPⱼ(Pᵢ) all the supporting X variables are already visible, then Tₚ_{ᵢ}_{,j}=(pᵢ′ [symbol] WPⱼ(Pᵢ);
else if WPⱼ(Pᵢ) is equivalent to (the negation of) another predicate Pₗ(X) or its negation, then Tₚ_{ᵢ}_{,j} equals (the negation of) the formula (pᵢ′ [symbol] pₗ);
else if enumerating the solutions of pᵢ′ and P variables for pᵢ′ [symbol] WPⱼ(Pᵢ)̂ [symbol] pₗ [symbol] Pₗ is feasible, the enumeration result is used instead. The result represents a relation over pᵢ′ and P;
otherwise, let Tₚ_{ᵢ}_{,j} be pᵢ′=(*)—by adding a fresh primary input to indicate a nondeterministic choice.

These heuristics are optional in that they do not affect the completeness of the overall CEGAR procedure. However, in practice they are very effective in reducing the spurious transitions, and hence avoiding the associated costs of model checking and large number of refinement iterations.

Additional heuristics can be used to improve the hybrid CEGAR procedure. These are based on a static identification of candidate variables to make visible quickly, and a lazy constraint technique to improve the quality of the unsatisfiable cores used for the purpose of refinement.

In static identification of Visible Variables, before the CEGAR loop starts, a simple static analysis is done on the CDFG to heuristically compute a small set of promising candidates of visible variables, i.e., variables that are likely to be made visible during the refinement process. In particular, the heuristic is used that for a state variable v, if (1) the next-state value of v is determined by some arithmetic expression over the current-state value of v, and (2) the variable v appears in some conditional expression guarding an error block, then v is a promising candidate visible variable.

However, these precomputed candidates are not added as visible variables upfront, since static analysis alone is not a good indicator that these variables are needed to verify the property at hand. Instead, during refinement, if a candidate variable v appears in the support of a predicate Pₗ(X) in the UNSAT core, then v is added as a visible variable even if its accumulative cost cost_{P}(v) is not yet large enough.

The process can precompute candidates of visible variables. In other words, the system bypasses the step of first generating new predicates based on WP-based analysis. This is because in the subsequent refinement iterations, it is likely that a large number of new predicates (corresponding to the WP of Pₗ) are needed, due to the nature of v's transition function. In FIG. 4, for instance, if the predicate (v<1024) is in the UNSAT core, the subsequent refinements will add (v+x<1024), (v+2x<1024), . . . as predicates—this is precisely the situation to avoid. In the hybrid abstraction, the situation can be avoided by adding v as a visible variable immediately after the addition of the new predicate (v<1024).

Next, Lazy Constraints in UNSAT Core will be discussed. An UNSAT core derived by the SAT solver can be used for refinement, both for spurious transitions (by identifying correlation constraints in the UNSAT core) and for spurious segments (by identifying the conditional expressions in the UNSAT core). There are often multiple UNSAT cores for the same unsatisfiable problem, and the SAT solver by default may not generate an UNSAT core that is better for refinement.

Consider the example in FIG. 5, where a spurious counterexample is shown on the left. Imagine that, for instance, lines 4 and 8 have complex loop bodies guarded by the conditions in lines 3 and 7, respectively; and the loop bodies contain i=i+1 and j=j+1. For this spurious counterexample, there are the UNSAT cores:
Lines 1, 2 and 3,
Lines 5, 6 and 7,
Lines 1, 2, 5, 6, 9 and 10,
Lines 3, 7 and 10.

Although any of these UNSAT cores can be used to remove the spurious counterexample, the last one is better since it immediately proves that ERROR is not reachable, as shown on the right of FIG. 5. The weakest precondition of P:(k<A+B) is Q:(i+j<A+B), which is implied when both R:(i<A) and S:(j<B) are true.

Modern SAT solvers are likely to report one of the first three UNSAT cores, due to the eager unit clause propagation used during pre-processing to handle the assignments to constants (lines 1, 2, 5, and 6). In this example, WP computation has to consider the (potentially complex) loop bodies. For instance, if the loops contains i=i+1 and j=j+1, then using the first UNSAT core will result in 1024 predicates.

This situation is avoided by formulating the satisfiability problem in a slightly different way. For each assignment statement of the form stᵢ: v:=const in the spurious counterexample, the constraint in the corresponding SAT problem is (vⁱ=const). The system changes this constraint to:

(vⁱ=const [symbol] q)̂(vⁱ=const [symbol] q)

where q is a fresh Boolean variable. Note that the new constraint implies (vⁱ=const). However, the presence of the extra variable q prevents the SAT solver from eagerly propagating the unit clauses due to (vⁱ=const) during pre-processing. This reduces the chances of such constant assignments appearing in the UNSAT core reported by the SAT solver. Therefore, although this approach does not guarantee that the UNSAT core generated by the SAT solver provides the best refinement solution, it can significantly increase the chance of getting one.

This approach is similar to the lazy constraint method, where it was shown to be effective for finding good variable (latch) hiding abstractions. Here, it is applied in the context of predicate abstraction. Furthermore, the lazy constraints were applied at the bit-level, for modeling only the initial state values of latches. In contrast, they are applied at the word-level, to assignment statements appearing anywhere in the high-level description of the design or program. Another difference to note is that lazy constraints have been used for proof-based abstraction. In that setting, the use of lazy constraints can sometimes be expensive, especially on large problems corresponding to large concrete designs. In the setting, lazy constraints are used only during refinement, where the problem of checking the feasibility of an abstract counterexample is significantly smaller.

Experiments will be discussed next. The hybrid CEGAR procedure can be used for models represented as CDFGs. The proposed techniques are evaluated by comparing hybrid abstraction with the two existing abstraction methods—variable hiding and predicate abstraction—in the same CEGAR procedure. For the purpose of controlled experiments, the model checking algorithms are kept the same; both predicate abstraction and hybrid abstraction use the same weakest precondition based refinement algorithm to find new predicates, and variable hiding uses an UNSAT core based refinement algorithm to identify new visible variables. In the implementation, CUDD is used for BDD operations and a circuit SAT solver for SAT related operations. The experiments were conducted on a workstation with a 3 GHz Pentium 4 and 2 GB of RAM running Red Hat Linux.

A public Verilog front-end tool (called Icarus Verilog) is used to translate Verilog designs into functionally equivalent CDFGs. The benchmarks include the VIS Verilog benchmarks. All examples are available in public domain. For these examples, invariant properties, which are expressed as reachability of an error block, are checked. Among the test cases, AR is an example computing the Fibonacci numbers (the parameterized bit-width is set to 32, although in the original versions, the bit-vectors have sizes of 500, 1000, and 2000 in all arithmetic operations); pj_icram is an example which models a RAM unit of the PicoJava microprocessor; pj_icu is an example which models the Instruction Control Unit of the PicoJava microprocessor. The sdlx example is a sequential DLX processor that uses a load-store architecture. The arbiter example is a Tree Arbiter model, which has a counter of 8-bit width. tloop is a model containing three concurrently running submodules with long counters. The itc99 examples are the Verilog versions of the Torino benchmarks in ITC99-T.

TABLE 1
Comparing the three abstraction methods in the same CEGAR procedure

| Test Case | | | CPU Time (s) | | | Iterations | | | Vars/Preds | | | VCEGAR | | |
|---|---|---|---|---|---|---|---|---|---|---|---|---|---|---|
| name | bvars | prop | varhide | predabs | hybrid | varhide | predabs | hybrid | varhide | predabs | hybrid (v/p) | Time | Iters | Preds |
| AR | 96 | T | 3.4 | 0.5 | 0.5 | 3 | 6 | 5 | 96 | 6 | 0/6 | 0.5 | 3 | 4 |
| pj_icram | 243 | T | 4.4 | 3.5 | 3.6 | 8 | 8 | 9 | 107 | 21 | 13/8 | 21.5 | 2 | 3 |
| pj_icu | 8060 | T | 84 | 68 | 23 | 2 | 2 | 2 | 1228 | 46 | 37/9 | 0.7 | 2 | 6 |
| sdlx | 124 | T | 39 | 20 | 14 | 14 | 15 | 15 | 42 | 28 | 24/4 | 42.6 | 20 | 43 |
| tloop | 127 | T | TO | 3.3 | 3.1 | — | 6 | 6 | — | 15 | 9/6 | TO | — | — |
| arbiter | 121 | T | 43.5 | TO | 401 | 13 | — | 20 | 50 | — | 13/37 | TO | — | — |
| itc99-a | 9 | F | 0.2 | 0.6 | 0.3 | 3 | 5 | 4 | 2 | 6 | 4/2 | 0.6 | 2 | 12 |
| itc99-b | 74 | T | 32 | 73 | 17 | 11 | 13 | 11 | 60 | 47 | 32/3 | 7.5 | 8 | 35 |
| itc99-c | 71 | F | 7.9 | 18 | 9.0 | 7 | 10 | 8 | 24 | 28 | 22/1 | 2.7 | 4 | 17 |
| itc99-d | 71 | F | 225 | TO | 692 | 11 | — | 16 | 65 | — | 45/8 | TO | — | — |

(TO—timed out after 1 hour)

The first three columns of Table 1 provide statistics on the examples: the first column shows the names of the designs; the second column shows the numbers of binary state variables (or registers) in the cone of influence, and the third column indicates whether the property is true. The next three columns compare the CPU time of the CEGAR procedure with different abstraction methods—varhide denotes variable hiding, predabs denotes predicate abstraction, and hybrid denotes the hybrid abstraction. The next three columns compare the number of iterations of the CEGAR procedure needed to prove the properties. The next three columns compare the final abstract models in terms of (Vars/Preds), i.e., the number of visible variables and the number of predicates, respectively. (Here a final abstract model is a model on which the property can be decided.) The last three columns show the results for the VCEGAR tool—the CPU time, the number of iterations, and the size of the final abstract models. All the experiments used the latest binary of VCEGAR (version 1.1).

Overall, the hybrid abstraction makes the CEGAR procedure more robust. The performance of hybrid consistently matched the better of the two existing methods varhide and predabs. For half of the examples, hybrid obtained the best runtime performance among the three. This may be due to the hybrid model being more concise than either of the two extremes. It is interesting to note that even though the currently implemented refinement approach is slightly biased toward predicates (converting predicates to visible variables, and not vice versa), the final abstract model in all examples included a non-trivial number of visible variables (other than x_{pc}). Note also that the implementation of pure predicate abstraction has a runtime performance comparable to VCEGAR, although it computes abstractions at a significantly finer granularity.

More specifically, note that predicate abstraction timed out on the arbiter example, since a large number of predicates of the form (i+counter <=127) such that i=1, 2, . . . is required (exponential in the bit-width of variable counter). The itc99-d example is also hard for pure predicate abstraction, since it has a very long counterexample and requires a large number of predicates. Pure variable hiding abstraction worked well on these two examples, because it is able to localize the property to a small subset of variables (the final abstract model for arbiter, including the variable counter, has 50 Boolean state variables). The hybrid abstraction uses the same WP-based refinement algorithm as in predicate abstraction, but achieved a runtime performance and final sizes similar to variable hiding.

On the other hand, pure variable hiding was the slowest on the AR example, since it added all the variables of the model to prove the property (the final abstraction has 96 Boolean state variables). In contrast, both predicate abstraction and hybrid abstraction produced much smaller final abstract models (with only 6 Boolean state variables). Variable hiding also timed out on the tloop example, which has a CDFG structure similar to the one in FIG. 5; variable hiding is inefficient for this example because the abstract model contains several complex arithmetic operations (large adders). The implementations of both predicate abstraction and hybrid abstraction completed this example. VCEGAR did not complete the tloop example because its refinement is based on the standard UNSAT core reported by zChaff, which results in the addition of a number of predicates. In contrast, the lazy constraint heuristic refinement was used to obtain a more useful UNSAT core. This allowed a simpler abstract model to be built and therefore complete this example quickly.

In sum, the hybrid abstraction method combines variable hiding with predicate abstraction in the same counterexample guided abstraction refinement loop. Refinements based on weakest preconditions to add new predicates can be used, and under certain conditions trade in the predicates for visible variables in the abstract model. Heuristics for improving the overall performance can be based on static analysis to identify useful candidates for visible variables, and lazy constraints can be used to find more effective refinement. The experiments show that hybrid abstraction frequently outperforms the existing abstraction methods—it makes the CEGAR procedure more robust. Other static analysis techniques can be used to speed up the abstraction computation and to help computing better refinements.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A process for verifying the correctness of a design, comprising:
a. transforming the design into a Control and Data Flow Graph (CDFG);
b. generating a hybrid abstract model; and
c. checking the correctness of the hybrid abstract model.

2. The method of claim 1, wherein the hybrid abstract model is generated by an abstraction through variable hiding and predicate abstraction.

3. The method of claim 2, wherein the abstraction allows visible state variables and predicates in the hybrid abstract model.

4. The method of claim 1, wherein abstraction is comprised of precomputing one or more visible variables.

5. The method of claim 1, comprising applying one or more syntactic rules to efficiently build the hybrid abstract model.

6. The method of claim 1, wherein checking the correctness comprises applying a counterexample guided abstraction refinement.

7. The method of claim 6, comprising
a. performing an initial abstraction of the design;
b. determining one or more counterexamples for the hybrid abstract model;
c. performing concretization of the counterexample to check whether the counterexample is spurious;
d. refining the hybrid abstract model based on the spurious counterexample, and
e. repeating steps b-d, until there are no more counterexamples or a true counterexample is found.

8. The method of claim 6, comprising evaluating the cost of the hybrid abstract model.

9. The method of claim 6, comprising deciding, during refinement, when to trade new predicates for visible variables.

10. The method of claim 6, comprising applying UNSAT core based refinement algorithm to add one or more correlation constraints on-demand to remove spurious transitions.

11. The method of claim 6, comprising applying a set of syntactic level rules to add correlation constraints.

12. The method of claim 11, wherein the correlation constraints comprise visible variables and predicates, and among predicates.

13. The method of claim 6, comprising
a. using one or more word-level lazy constraints in the hybrid abstract model; and
b. using UNSAT core computation to improve the quality of the refinement.

14. The method of claim 1, comprising automatically transforming word-level Verilog designs into functionally equivalent CDFGs.

15. The method of claim 1, comprising generating the CDFG for a word-level hardware (reactive model).

16. The method of claim 1, comprising generating the CDFG for a software program (sequential model).

17. A system to check a design comprising:
a. a converter to transform the design into a Control and Data Flow Graph (CDFG);
b. a module to perform a hybrid abstraction of the design and to generate a hybrid abstract model; and
c. a verifier to check the hybrid abstract model.

18. The system of claim 17, wherein the hybrid abstract model is generated by an abstraction through variable hiding and predicate abstraction.

19. The system of claim 18, wherein the abstraction allows visible state variables and predicates in the hybrid abstract model.

20. The system of claim 17, wherein abstraction is generated by precomputing one or more visible variables.

21. The system of claim 17, wherein the module applies one or more syntactic rules to efficiently build the hybrid abstract model.

22. The system of claim 17, wherein the verifier checks the correctness by applying a counterexample guided abstraction refinement.
